(19) United States
(12) Patent Application Publication
(10) Pub. No.: US 2008/0191851 A1
(43) Pub. Date: Aug. 14, 2008

(54) POWER LINE COMMUNICATION APPARATUS, REGISTRATION STATUS CONFIRMATION METHOD, AND POWER LINE COMMUNICATION SYSTEM

(75) Inventor: Hisao KOGA, Fukuoka (JP)

Correspondence Address: DICKINSON WRIGHT PLLC, 1901 L STREET NW, SUITE 800, WASHINGTON, DC, 20036, US

(73) Assignee: MATSUSHITA ELECTRIC INDUSTRIAL CO., LTD., Osaka (JP)

(21) Appl. No.: 12/030,778

(22) Filed: Feb. 13, 2008

(30) Foreign Application Priority Data
Feb. 13, 2007 (JP) 2007-032113

(51) Int. Cl. G05B 11/01

(52) U.S. Cl. 340/310.11

(57) ABSTRACT

A power line communication apparatus capable of performing power line communications with an other power line communication apparatus, the power line communication apparatus, including an authentication processing part which performs an authentication process using at least either an authentication request signal or an authentication response signal with the other power line communication apparatus via a power line, and a signal transmitting part which transmits a predetermined signal to the other power line communication apparatus so that the other power line communication apparatus indicates that the other power line communication apparatus and the power line communication apparatus are made communicatable to each other by the authentication process.

### BACKGROUND

The present invention relates to a power line communication apparatus, a registration status confirmation method, and a power line communication system.

With power line communication apparatuses performing power line communications using a power line, a process for making a power line communication apparatus ready for communications (hereinafter referred to as an authentication process) is performed in order to ensure secure and reliable communications between two or more power line communication apparatuses. Examples of the authentication process include authentication and a security setting process.

A general authentication process will be briefly described using FIG. 15. This example assumes that an authentication process is performed between a power line communication apparatus 1500A and a power line communication apparatus 1500B, with the power line communication apparatus 1500A managing the authentication process. When the power line communication apparatus 1500B issues an authentication request to the power line communication apparatus 1500A (step S1501), an authentication response is returned from the power line communication apparatus 1500A (step S1502). In case the authentication request is permitted, the power line communication apparatus 1500A makes a request for a key (step S1503) to the power line communication apparatus 1500B and the power line communication apparatus 1500B makes a response for a key to the power line communication apparatus 1500A (step S1504). To make a request or a response for a key, various information that is known to only these power line communication apparatuses, such as a random number generated according to a MAC address inherent to a modem or a time stamp, is transmitted to each other. The power line communication apparatuses 1500A and 1500B generate a key based on various information transmitted to each other (step S1505). The power line communication apparatus 1500A uses the generated key to transmit a network key shared in a network to other power line communication apparatuses constituting the network (step S1506).

Another example of the authentication process is a cryptographic key setup process in a wireless LAN environment. In wireless LAN, a cryptographic key setup process to add a new terminal that uses the network by way of a simple method is known as a cryptographic key setup method to perform a cryptographic process. The cryptographic key setup method performs a cryptographic key setup process by arranging a target terminal within the coverage area of an access point as a repeater for wireless LAN and pressing a one-touch registration button at each of the access point and the terminal (for example, refer to JP-A-2005-175524).

When a power line communication apparatus is plugged into an outlet and an authentication process is made, a power line network with another power line communication apparatus can be configured. A plurality of power line networks can be configured in the same coverage area. For example, in the environment shown in FIG. 16 are arranged a power line network 1610A to which a power line communication apparatus 1600A is connected, a power line network 1610B to which a power line communication apparatus 1600B is connected, a power line network 1610C to which a power line communication apparatus 1600C is connected, and a power line network 1610D to which a power line communication apparatus 1600D is connected. FIG. 16 shows an example of a network environment where general power line communication apparatuses are arranged.

In such an environment including various power line networks, it is sometimes difficult for a power line communication apparatus to correctly perform an authentication process with another power line communication apparatus in an attempt to configure a new power line network. For example, in the environment shown in FIG. 17A, the power line communication apparatus 1600A can perform an authentication process with any one of the power line communication apparatuses 1600B, 1600C and 1600D. In the environment is shown in FIG. 17B, in case an authentication process is performed between the power line communication apparatus 1700A and the power line communication apparatus 1700B, the power line communication apparatus 1700A can detect the power line communication apparatus 1700B but it is unknown whether the power line communication apparatus 1700B can detect the power line communication apparatus 1700A. Thus, the power line communication apparatus 1700A may fail to correctly perform an authentication process with the power line communication apparatus 1700B. FIG. 17A and FIG. 17B show examples of a coverage area assumed when general power line communication apparatuses communicate with each other.

In an authentication process between power line communication apparatuses, it is desirable that an exclusive authentication process be reliably performed between desired power line communication apparatuses even in the environment shown in FIG. 17A or 17B. It is also desirable to be able to confirm whether an authentication process has been reliably performed between desired power line communication apparatuses.

### SUMMARY

The invention has been accomplished to solve the above problems. An object of the invention is to provide a power line communication apparatus, a power line communication system and a registration status confirmation method capable of more correctly confirming that an authentication process has been performed between desired power line communication apparatuses even in case a plurality of power line communication apparatuses are connected to a power line. Another object of the invention is to provide a power line communication apparatus, a power line communication system, a registration status confirmation method, and an authentication process method capable of reliably performing an authentication process between desired power line communication apparatuses even in case a plurality of power line communication apparatuses are connected to a power line.

Described below is a power line communication apparatus capable of performing power line communications with an other power line communication apparatus, the power line communication apparatus, including: an authentication processing part which performs an authentication process using at least either an authentication request signal or an authentication response signal with the other power line communication apparatus via a power line; and a signal transmitting part which transmits a predetermined signal to the other power line communication apparatus so that the other power line communication apparatus indicates that the other power line communication apparatus and the power line communication apparatus are made communicatable to each other by the authentication process.

With this configuration, it is possible to confirm that an authentication process has been reliably performed by desired power line communication apparatuses even in case a plurality of power line communication apparatuses are connected to a power line.

Described below is a registration status confirmation method for confirming a registration status between power line communication apparatuses performing power line communications via a power line, the method including: transmitting a registration status confirmation signal instructing confirmation of the registration status from a first power line communication apparatus connected to the power line to a second power line communication apparatus connected to the power line; and indicating that the second power line communication apparatus is communicatable to the first power line communication apparatus in the second power line communication apparatus that receives the registration status confirmation signal.

With this configuration, it is possible to confirm that an authentication process has been reliably performed between desired power line communication apparatuses even in case a plurality of power line communication apparatuses are connected to a power line. By indicating that an authentication process has been performed between power line communication apparatuses for example by way of an LED, it is possible to confirm that an authentication process has been appropriately performed with a power line communication apparatus as a source of a registration status confirmation signal.

Described below is a power line communication system in which power line communications are enabled by a first power line communication apparatus and a second power line communication apparatus,

wherein the second power line communication apparatus transmits an authentication request signal via a power line;

wherein the first power line communication apparatus transmits an authentication response signal in response to the authentication request signal; and

wherein the first power line communication apparatus transmits a predetermined signal to the second power line communication apparatus to allow the second power line communication apparatus to indicate that the first power line communication apparatus and the second power line communication apparatus are made communicatable to each other by way of an authentication process using the authentication request signal and the authentication response signal.

With this configuration, it is possible to confirm that an authentication process has been reliably performed by desired power line communication apparatuses even in case a plurality of power line communication apparatuses are connected to a power line.

With the invention, it is possible to confirm that an authentication process has been reliably performed by desired power line communication apparatuses in case a plurality of power line communication apparatuses are connected to a power line. It is also possible to reliably perform an authentication process between desired power line communication apparatuses in case a plurality of power line communication apparatuses are connected to a power line.

### BRIEF DESCRIPTION OF THE DRAWINGS

The above objects and advantages of the present invention will become more apparent by describing in detail preferred exemplary embodiments thereof with reference to the accompanying drawings, wherein like reference numerals designate like or corresponding parts throughout the several views, and wherein:

FIG. 1 is an external perspective view of the front of a PLC modem according to an embodiment of the invention;

FIG. 2 is an external perspective view of the rear of the PLC modem according to the embodiment of the invention;

FIG. 3 shows an example of a hardware of the PLC modem according to the embodiment of the invention;

FIG. 4 shows an example of a frequency diversity signal used by the PLC modem according to the embodiment of the invention;

FIG. 5 shows an example of a time diversity signal used by the PLC modem according to the embodiment of the invention;

FIG. 6 shows an example of a frequency-time diversity signal used by the PLC modem according to the embodiment of the invention;

FIG. 7 shows an example of the data frame structure according to the embodiment of the invention;

FIG. 8 shows an example of the operation flow of the PLC modem functioning as a master unit in an authentication process according to the embodiment of the invention;

FIG. 9 shows an example of the operation flow of the PLC modem functioning as a slave unit in an authentication process according to the embodiment of the invention;

FIG. 10A shows the relationship between the setup period and the monitoring period according to the embodiment of the invention;

FIG. 10B shows an example of the operation flow of a PLC modem in an authentication process using a monitoring period according to the embodiment of the invention.

FIG. 10C shows an example of an authentication process on a time axis performed by PLC modems using a monitoring period according to the embodiment of the invention;

FIG. 11 shows an example of the operation of a PLC modem in an authentication process using a monitoring period according to the embodiment of the invention;

FIG. 12 shows an example of the operation of a PLC modem to change the setup period according to the embodiment of the invention;

FIG. 13 shows an example of the operation of a PLC modem that has detected a setup disable signal according to the embodiment of the invention;

FIG. 14A shows an example of the operation of a PLC modem transmitting a registration confirmation signal according to the embodiment of the invention;

FIG. 14B shows an example of the operation of a PLC modem receiving a registration confirmation signal according to the embodiment of the invention;

FIG. 15 shows a procedure for a general authentication process;

FIG. 16 shows an example of a network environment where general power line communication apparatuses are arranged;

FIG. 17A shows an example of a coverage area assumed when general power line communication apparatuses communicate with each other; and

FIG. 17B shows an example of a coverage area assumed when general power line communication apparatuses communicate with each other.

### DETAILED DESCRIPTION

A power line communication apparatus according to this embodiment will be described using figures.

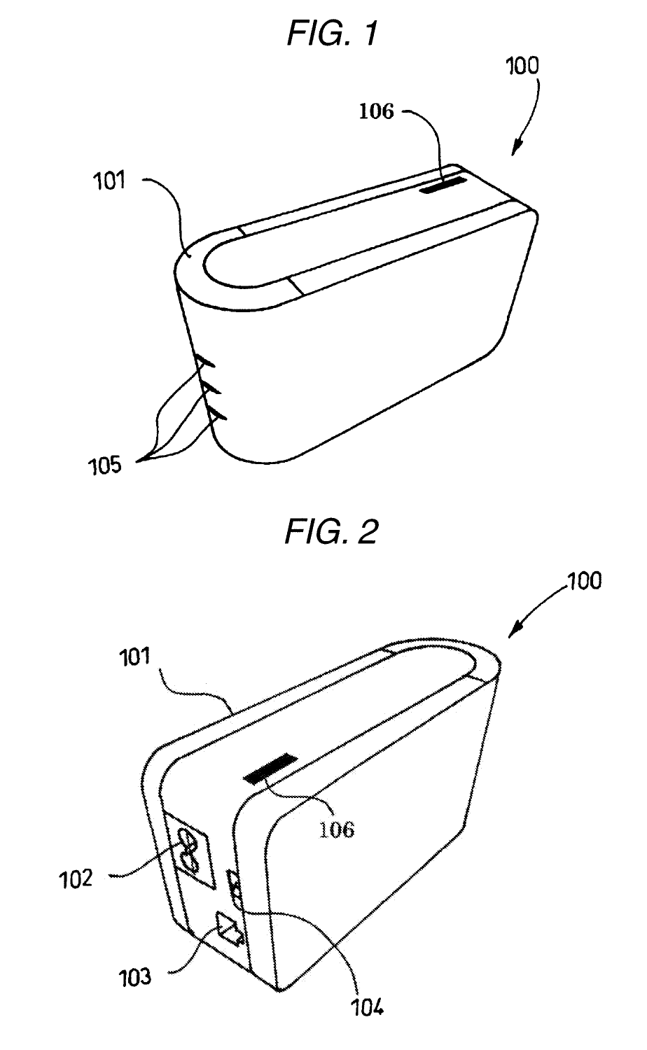

FIG. 1 is an external perspective view of the front of a PLC (Power Line Communication) modem 100 as an example of the power line communication apparatus. FIG. 2 is an external perspective view of the rear of the PLC modem 100. The PLC modem 100 shown in FIGS. 1 and 2 includes an enclosure 101. On the front of the enclosure 101 is arranged an indicator 105 such as an LED (Light Emitting Diode) as shown in FIG. 1.

On the rear of the enclosure 101 are arranged a power connector 102, a LAN (Local Area Network) modular jack 103 such as RJ45, and a selector switch 104 to select among operation modes, as shown in FIG. 2.

On the upper surface of the enclosure 101 is arranged a button 106. The button 106 functions as an authentication confirmation button for confirming whether correct authentication and security setting (hereinafter referred to as an authentication process) has been made and as a setup button to start the authentication process. While the button 106 is arranged on the upper surface of the enclosure 101 in this example, the position of the button 106 is not limited thereto. The authentication confirmation button or the setup button are examples of an “operation part”.

To the power connector 102 is connected a power cable (not shown). To the modular jack 103 is connected a LAN cable (not shown). The PLC modem 100 may further include a D-sub (D-subminiature) connector to connect a D-sub cable.

While the PLC modem 100 is shown as an example of the power line communication apparatus, a power line communication apparatus may be electrical apparatus including a built-in PLC modem. Electrical apparatus includes, for example, a household electrical appliance such as a television set, a telephone set, a videocassette recorder, or a set-top box and OA equipment such as a personal computer, a facsimile, and a printer.

The PLC modem 100 is connected to a power line 700 and constitutes a power line communication system together with other PLC modems.

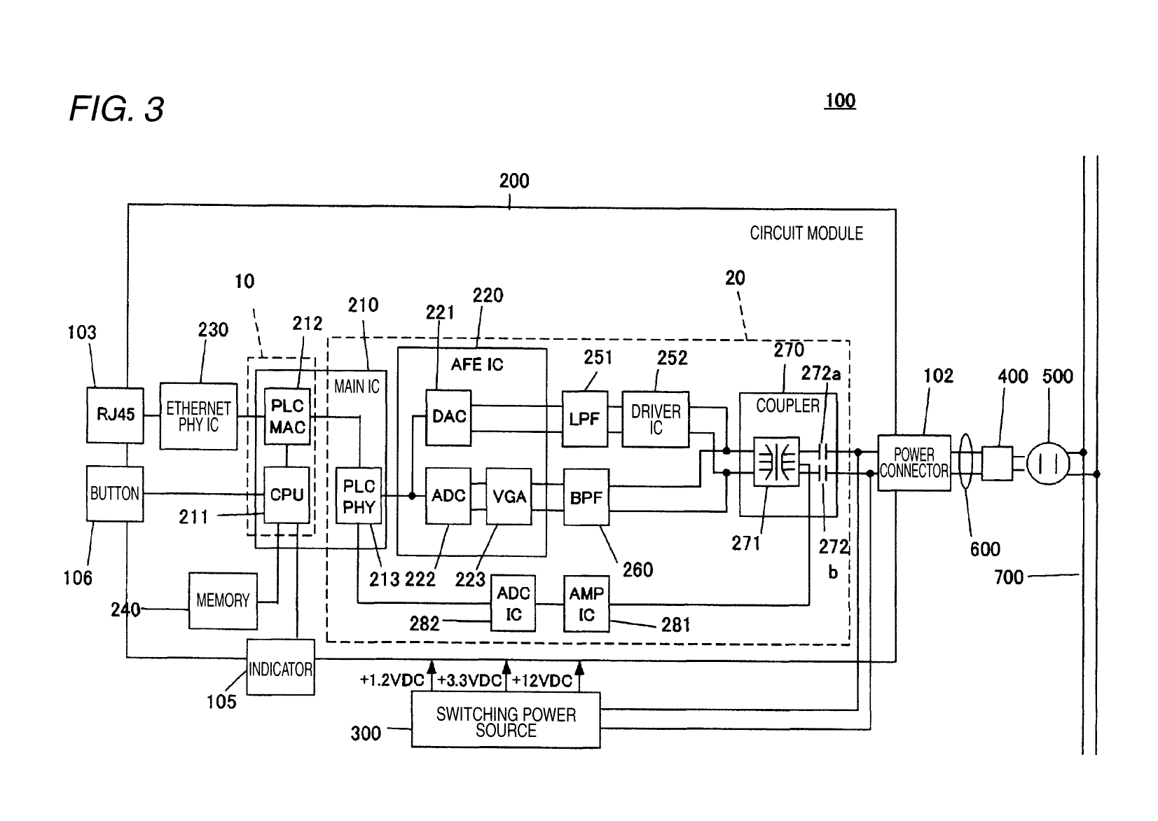

Next, an example of the hardware of the PLC modem 100 is shown in FIG. 3. The PLC modem 100 includes a circuit module 200 and a switching power source 300. The switching power source 300 is designed to supply various voltages (such as +1.2V, +3.3V and +12V) to a circuit module 200. The switching power source 300 includes, for example, a switching transformer and a DC-DC converter (either not shown).

The circuit module 200 includes a main IC (Integrated Circuit) 210, an AFE IC (Analog Front End Integrated Circuit) 220, an Ethernet PHY IC (Physical Layer Integrated Circuit) 230, a memory 240, a low-pass filter (LPF) 251, a driver IC 252, a band-pass filter (BPF) 260, a coupler 270, an AMP (Amplifier) IC 281, and an ADC (A/D converter) IC 282. The switching power source 300 and the coupler 270 are connected to a power connector 102 and connected to the power line 700 via a power cable 600, a power plug 400 and an outlet 500. The main IC functions as a control circuit for performing power line communications.

The main IC 210 is composed of a CPU (Central Processing Unit) 211, a PLC MAC (Power Line Communication Media Access Control layer) block 212 and a PLC PHY (Power Line Communication Physical layer) block 213.

The CPU 211 mounts a 32-bit RISC (Reduced Instruction Set Computer) processor. The PLC MAC block 212 manages the MAC layer (Media Access Control layer) of a transmit/receive signal. The PLC PHY block 213 manages the PHY layer (Physical layer) of a transmit/receive signal.

The AFE IC 220 is composed of a DAC (D/A Converter) 221, an ADC (A/D Converter) 222, and a VGA (Variable Gain Amplifier) 223. The coupler 270 is composed of a coil transformer 271 and coupling capacitors 272a, 272b.

The CPU 211 uses the data stored in the memory 240 to control the operation of the PLC MAC block 212 and the PLC PHY block 213 as well controls the entire PLC modem 100. The memory 240 stores processing programs of the CPU, a device registration list 241 described later, and various types of process information. The memory 240 is a “device registration storage” and an example of the “process information recording part”.

Communications by the PLC modem 100 are generally made in the following way. Data inputted from the modular jack 103 is transmitted to the main IC 210 via the Ethernet PHY IC 230 and is then subjected to digital signal processing to generate a digital transmit signal. The digital transmit signal thus generated is converted to an analog signal by way of the D/A converter (DAC) 221 of the AFE IC 220 and outputted to the power line 700 via the low-pass filter 251, the driver IC 252, the coupler 270, the power connector 102, the power cable 600, the power plug 400, and the outlet 500.

The signal received from the power line 700 is transmitted to the band-pass filter 260 via the coupler 270, subjected to gain adjustment by the Variable Gain Amplifier (VGA) 223 of the AFE IC 220, and then converted to a digital signal by the A/D Converter (ADC) 222. The resulting digital signal is transmitted to the main IC 210 and converted to digital data by way of digital signal processing. The digital data thus obtained is outputted from the modular jack 103 via the Ethernet PHY IC 230.

The functions of the PLC modem 100 will be described. The CPU 211 and the PLC MAC block 212 function as a controller 10. The PLC PHY block 213, the AFE IC 220, the LPF 251, the driver IC 252, the BPF 260, and the coupler 270 function as a communication part 20.

The communication part 20 performs various types of communications with another PLC modem 100 on the network. The communication part 20 has functions of a “signal transmitting part” for transmitting a predetermined signal and a “signal receiving part” for receiving a predetermined signal. The controller 10 performs various controls on the entire PLC modem 100, as well as detects a push on a button, monitors a signal transmitted/received by the communication part 20 during communications with another terminal, and changes the setup period described later, etc. The controller 10 has functions of a “registration confirmation processing part” for performing registration confirmation for an authentication process with another PLC modem 100 and an “authentication processing part” for performing an authentication process to enable communications with another PLC modem 100.

Next, a communication signal used by the PLC modem 100 to perform an authentication process will be described. The signal used in this example is a robust-form signal.

When transmitting a control signal or the like, the communication part 20 uses a diversity signal utilizing the frequency diversity that is based on the frequency region, the time diversity that is based on the time region, or frequency-time diversity that is based on both of the frequency region and the time region. Further, robust error correcting techniques using concatenated codes, Turbo codes, and LDPC (Low Density Parity Check) codes may be added.

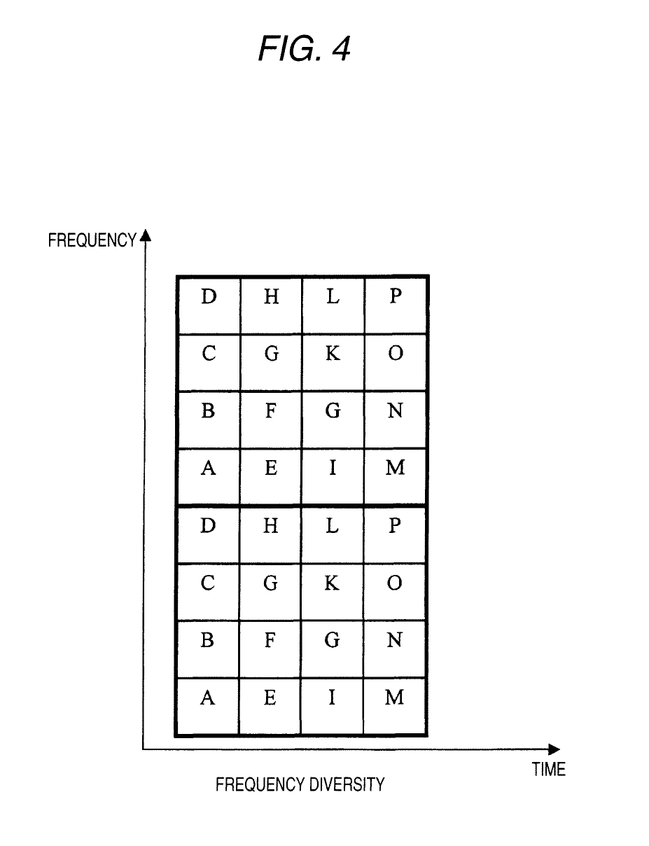

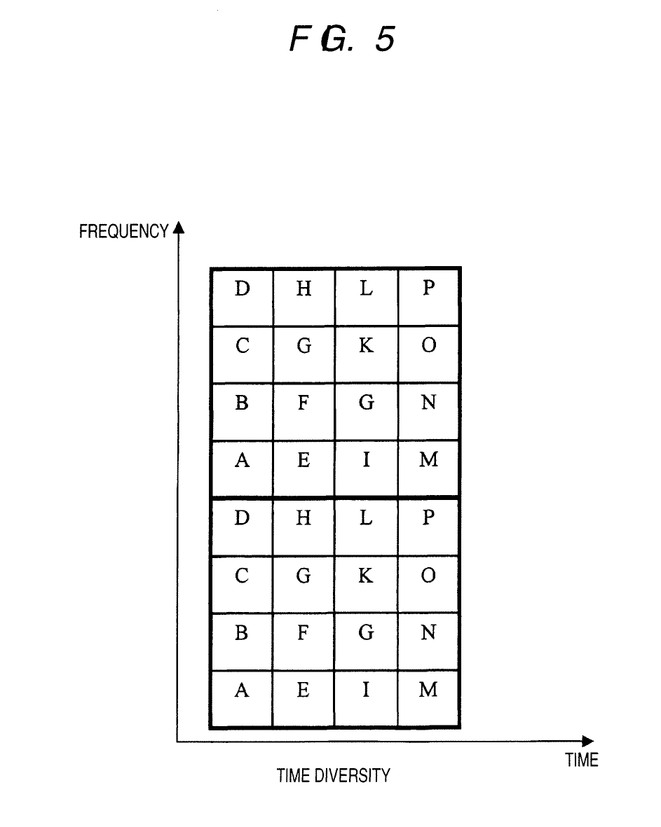

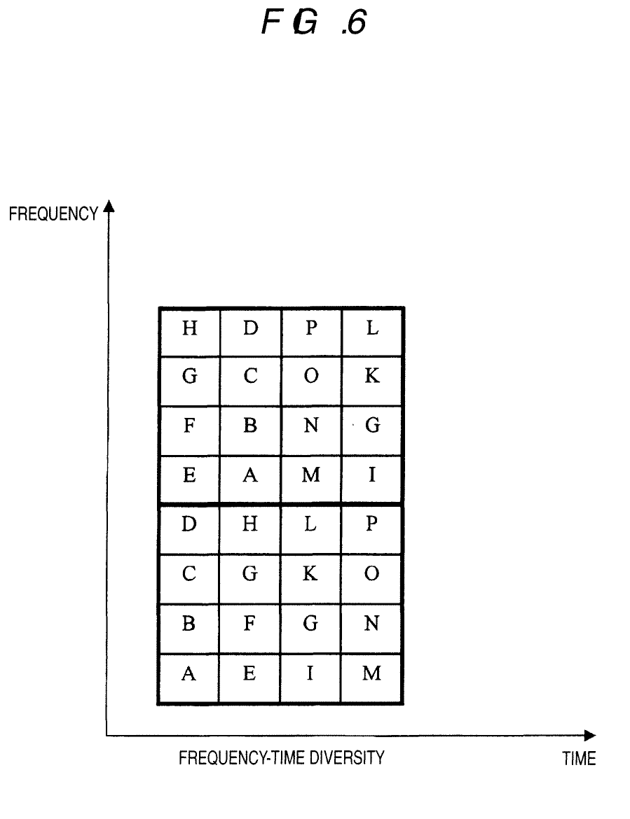

FIG. 4 shows an example of a diversity signal using the frequency diversity. FIG. 5 shows an example of a diversity signal using the time diversity. FIG. 6 shows an example of a diversity signal using the frequency-time diversity. As shown in FIGS. 4 through 6, a robust information signal is provided by incorporating repeatability in part of the information in the signal.

This ensures a simple and reliable authentication process even in case it is difficult to move a household electrical appliance incorporating a PLC modem 100 and household electrical appliances as targets of an authentication process are remote from each other.

In this way, the above robust signal ensures that a signal is robust in an authentication process thus allowing a more correct authentication process.

As the distance between PLC modems 100 to communicate with each other becomes long from each other, a transmit signal transmitted by one PLC modem 100 could be substantially attenuated before it is received by the other PLC modem 100. Even in such a case, a correct authentication process is ensured.

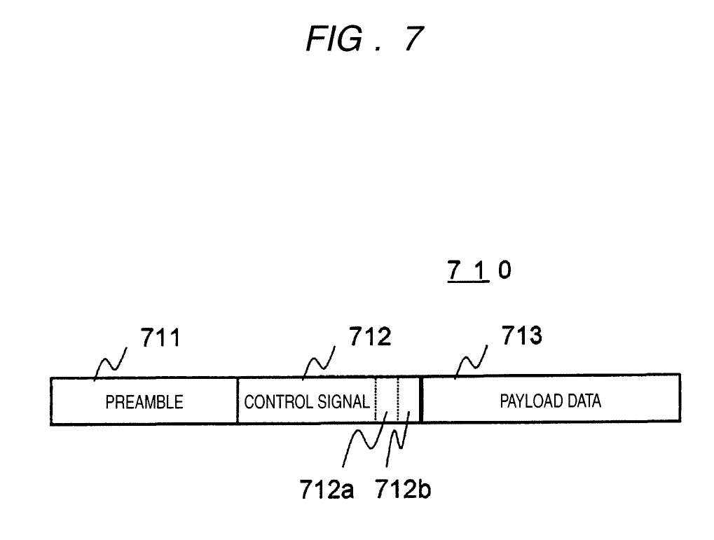

The structure of a data frame used by the PLC modem 100 to perform an authentication process will be described. FIG. 7 shows an example of the data frame structure. A data frame 710 has a preamble 711 including information necessary to transmit the data frame 710, a control signal 712 for performing communication control in an authentication process, and a payload 713 including actual data except the preamble 711 and the control signal 712.

The control signal 712 may include a setup starting signal 712a for notifying that an authentication process is to take place. The control signal 712 may include a setup disable signal 712b for notifying that an authentication process is disabled. While the setup starting signal is a single signal in FIG. 7, two signals, an authentication starting signal and a security starting setup signal may be used.

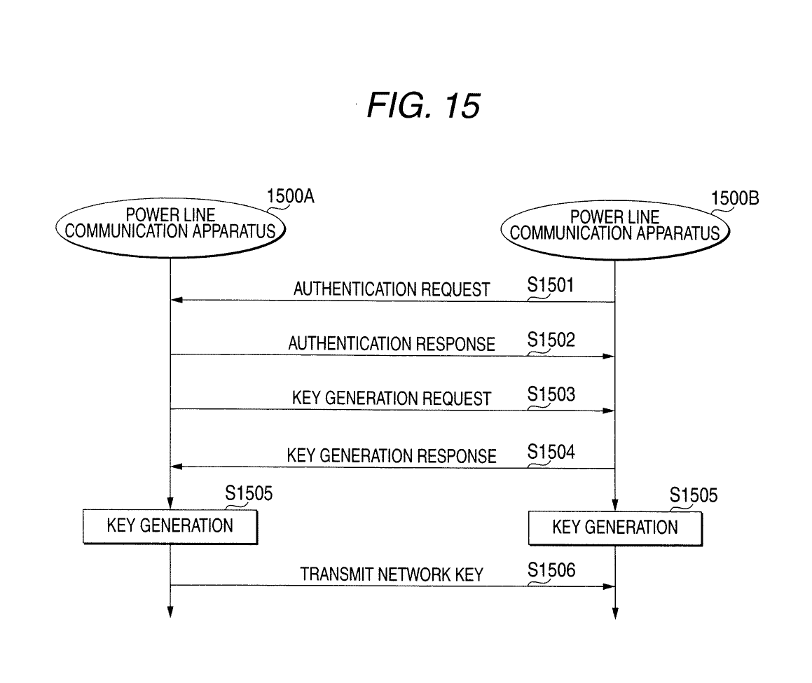

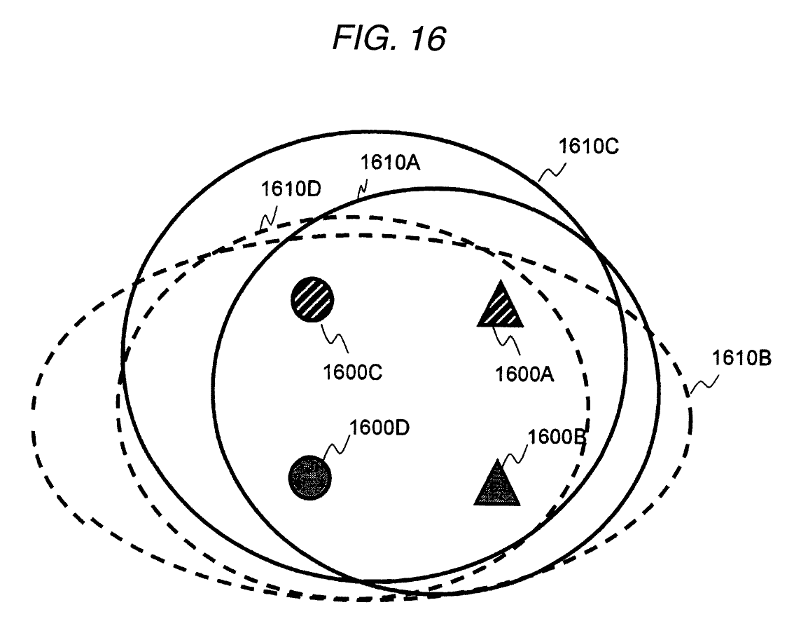

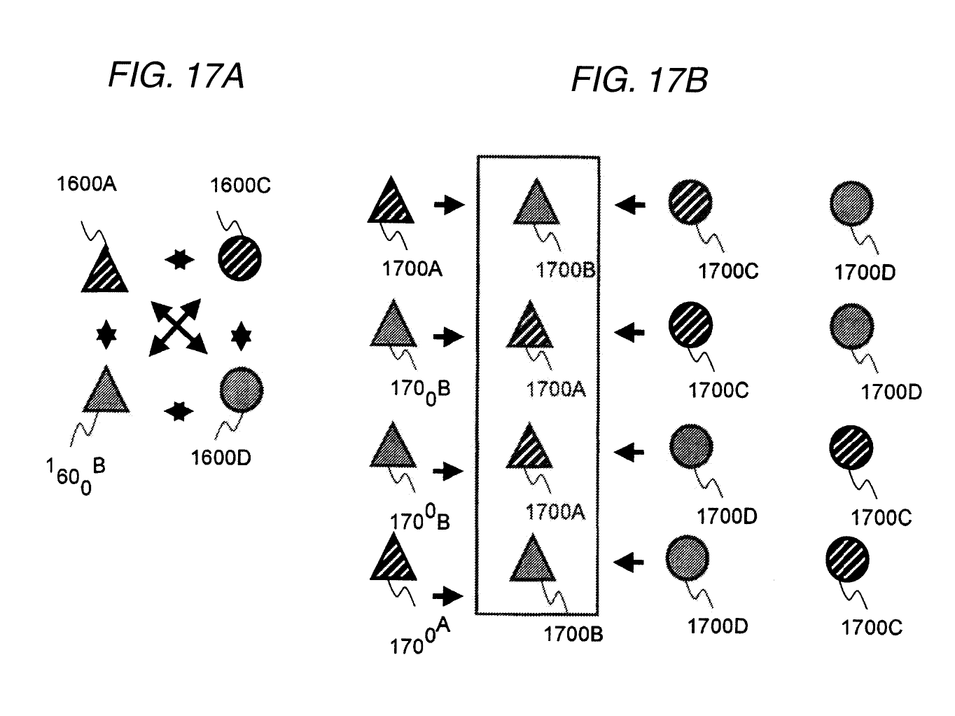

In FIG. 15 related to the above description, it is possible to encrypt the payload data 713 in the transmission frame in an authentication response and the subsequent authentication process, except for an authentication request.

Even in case the payload data 713 is encrypted, it is possible to confirm whether an authentication process is under way since the control signal 712 includes a setup starting signal.

The authentication process method will be described.

This example assumes an authentication process between a PLC modem 100A functioning as a master unit to manage an authentication process and a PLC modem 100B functioning as a slave unit for which an authentication process is managed. Note that the PLC modem 100A functioning as a master unit is not the only element that has to manage an authentication process. For example, in a distributed system, any one of the modems on a network may have the same function as that of the master unit and control an authentication process. While an example of the general authentication process method is shown in FIG. 15, the PLC modem 100A may make an authentication request and the PLC modem 100B may make an authentication response. This example details processes related to an authentication request and an authentication response in the authentication process and a description related to generation of a key and transmission of a network key is omitted.

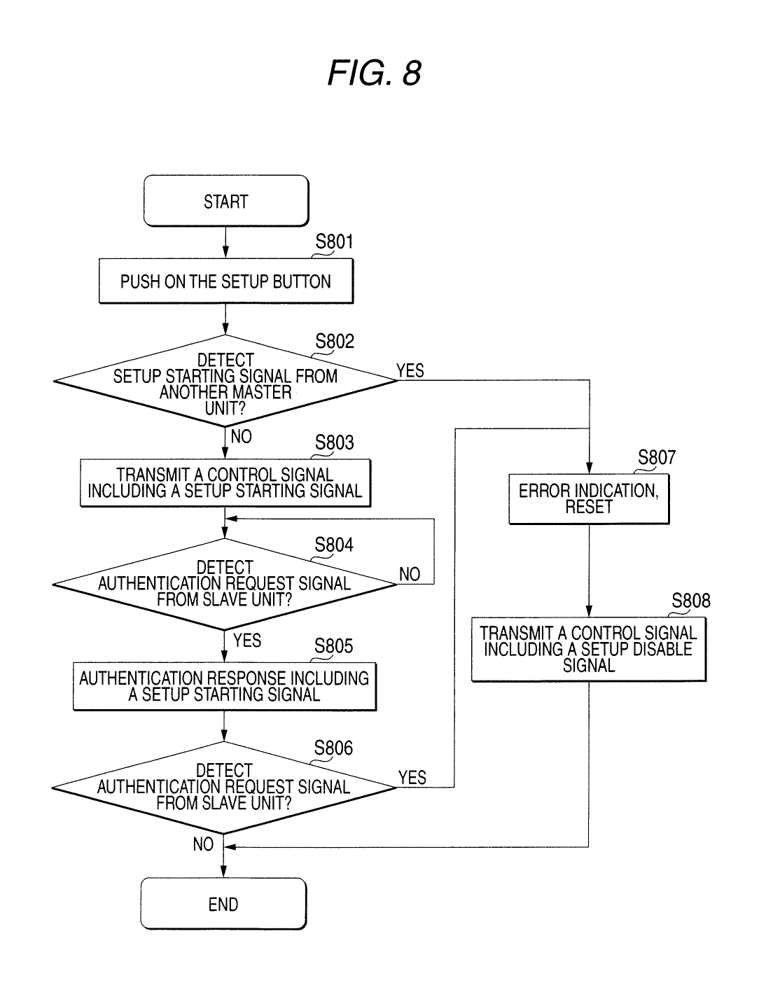

Operation of the PLC modem 100A in an authentication process between master and slave units will be described. FIG. 8 shows an example of the operation flow of the PLC modem 100A in an authentication process.

When the controller 10 detects a push on the setup button 106 of the PLC modem 100A (step S801), the controller 10 monitors a setup starting signal included in a control signal from another PLC modem 100A and determines whether the setup starting signal has been detected within a predetermined period (step S802).

A method for detecting a control signal 902 from another PLC modem 100A is described below. In case the control signal 902 transmitted by another PLC modem 100A uses a beacon, the beacon is received by the communication part 20 and the controller 10 determines whether it is a setup starting signal from the other PLC modem 100A, thus allowing detection of a setup starting signal from the other PLC modem 100A.

In case a setup starting signal from another PLC modem 100A is detected within a predetermined period, an indicator 105 gives an error indication by way of an LED and the controller 10 resets various settings to the initial state (step S807) to complete the process.

After that, the communication part 20 may transmit a control signal including a setup disable signal (step S808). While in case a setup disable signal is considered, a control signal including a setup disable signal is transmitted after an error indication, this order may be reversed.

In case a setup starting signal from another PLC modem 100A is not detected within a predetermined period, it is possible to perform an authentication process without being influenced by other PLC modems 100, so that the communication part 20 transmits a control signal including a setup starting signal (step S803).

After a control signal including a setup starting signal has been transmitted, the controller 10 waits, monitoring an authentication request signal, until an authentication request signal from the PLC modem 100B is detected (step S804). When an authentication request signal is detected, the communication part 20 uses a control signal including a setup starting signal to issue an authentication response (step S805).

A control signal capable of including a setup starting signal or a setup disable signal may be a control signal included as part of an ordinary data frame, or a signal composed of just a control signal such as a beacon, polling or a token.

In this way, in case a setup starting signal from any other PLC modem 100 is not detected, it is possible to perform an authentication process at that point in time. A correct authentication process is enabled by way of a continued authentication process.

After the authentication response, the controller 10 monitors whether an authentication request signal from another PLC modem 100B is generated until a predetermined period has elapsed (step S806). In case another authentication request signal from the other PLC modem 100B is not detected within the predetermined period, while not illustrated, the communication part 20 transmits a key generation request and detects a key generation response from the PLC modem 100B, and the controller 10 generate a key, and the communication part 20 transmits to the PLC modem 100B a network key shared within a power line network to which the PLC modem 100A is connected using the key, and completes the process. In case another authentication request signal from the other PLC modem 100B is detected within the predetermined period, an error indication process and transmission of a control signal including a setup disable signal in steps S807 and S808 follow.

As described above, in case plural authentication requests are detected as a result, it is impossible to determine which is the PLC modem 100B to be subjected to an authentication process, so that the authentication processes from all PLC modems 100B may be canceled. In case authentication request signals from a plurality of PLC modems 100B are detected, a setup disable signal may be transmitted. Thus, the second and the subsequent PLC modems 100B as well as the first PLC modem 100B that has been initially notified of completion of a correct authentication process may readily detect that the initial setup is invalid.

In this way, in case an additional authentication request is received after an authentication process is once performed, it is possible to notify that the completed authentication process is possibly an authentication error by simply transmitting a setup disable signal.

Concerning decision that plural authentication requests have been received from slave units, in FIG. 8 an authentication response is made immediately following an authentication request from the first PLC modem 100B and monitoring is made for an authentication request from a second or subsequent PLC modem 100B until a predetermined period elapses. ,An alternative determination process mentioned below may be used.

Even if an authentication request from a first PLC modem 100B in the step S804 is issued after a control signal including a setup start signal is transmitted by the PLC modem 100A, the PLC modem 100A does not immediately issue an authentication response regarding the first PLC modem 100B but monitors an authentication request signal from another PLC modem 100B until a predetermined period elapses. In this way, it is possible to initially assume an error in authentication for the first PLC modem 100B as well as the subsequent PLC modems 100B of the plurality of PLC modems 100B. This prevents an authentication response to the authentication request received from the first PLC modem 100B thus providing a more correct authentication process.

In an authentication process between a master unit and a slave unit, power control may be made over a control signal.

To be more precise, when transmitting a control signal including a setup starting signal (step S803), the communication part 20 of the PLC modem 100A transmits the control signal with reduced power. In case an authentication request from a PLC modem 100B is not detected for a predetermined period, the communication part 20 raises the power of the control signal. The communication part 20 repeats raising the power of the control signal until it detects an authentication request signal.

By controlling the power of the control signal, it is possible to suppress the possibility of an authentication error with other PLC modems 100 for which authentication setup is not assumed, and to suppress emission from a power line.

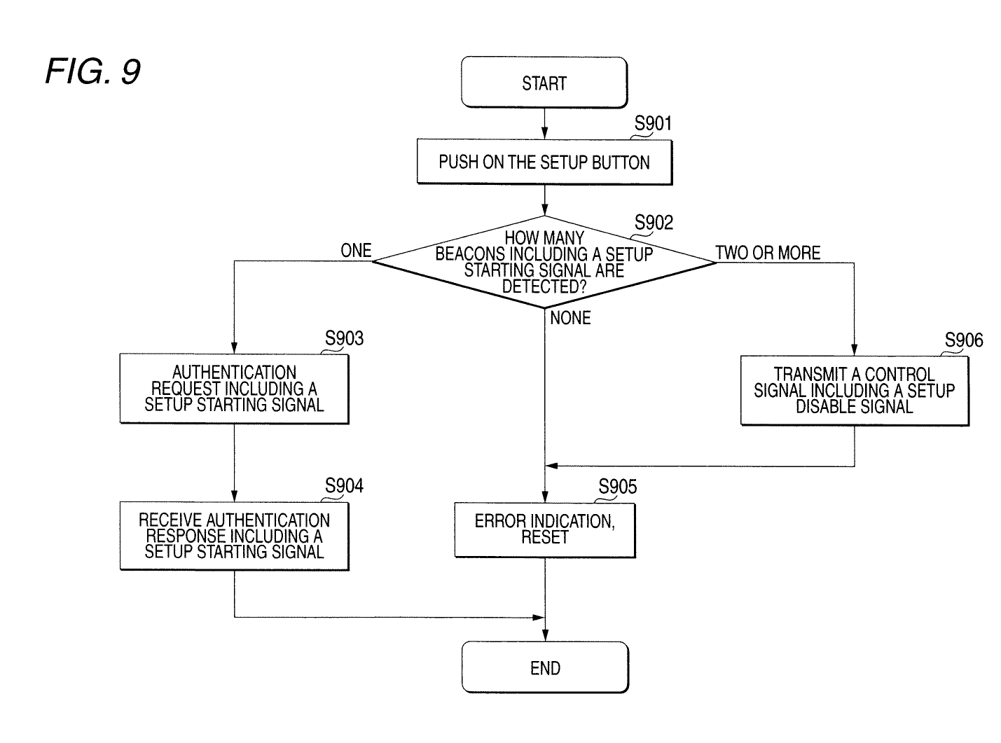

Next, the operation of the PLC modem 100B in an authentication process between a master unit and a slave unit will be described. FIG. 9 shows an example of the operation flow of the PLC modem 100B in an authentication process. While in this example the PLC modem 100A uses a beacon as a control signal, any other signal mentioned earlier may be used.

The controller 10 detects a push on the setup button 106 of the PLC modem 100B (step S901). The PLC modem 100A transmits a beacon at predetermined intervals. The controller 10 monitors beacons to check for beacons from the PLC modem 100A and determines how many beacons including a setup starting signal have been detected within a predetermined period (step S902).

When detecting only one beacon including a setup starting signal, the communication part 20 assumes that no other PLC modems 100A on the same network are engaged in an authentication process and issues an authentication request using a control signal including a setup starting signal (step S903). In response to this authentication request, the communication part 20 detects an authentication response including a setup starting signal from the PLC modem 100A as an authorized counterpart of authentication (step S904) to complete the process.

In case two or more beacons including a setup starting signal are detected within a predetermined period, the indicator 105 gives an error indication by way of an LED assuming that another PLC modem 100A on the same network is engaged in an authentication process, and the controller 10 resets various settings to the initial state (step S905) to complete the process. A beacon including a setup disable signal may be transmitted before an error indication (step S906). While a setup disable signal is transmitted, if any, before an error indication in FIG. 9, this order may be reversed.

In case no beacons are detected within a predetermined period, the indicator 105 gives an error indication by way of an LED, and the controller 10 resets various settings to the initial state (step S905) to complete the process.

In this way, in case only one setup starting signal is received from the PLC modem 100A, it is possible to perform an authentication process at that point in time. A correct authentication process is enabled by way of a continued authentication process.

In case a plurality of setup starting signals from PLC modems 100A are detected, it is possible to notify that a setup process is not to take place at that point in time.

While beacons are monitored for a predetermined period in the above example, in case the content of the beacon is confirmed and it is detected that the beacons are outputted from different modems, the same operation may be made by receiving the beacons without providing a beacon monitoring period.

Next, the operation of a PLC modem 100 in an authentication process using a monitoring period mentioned later will be described. FIG. 8 illustrates that, the controller 10 monitors, in an authentication process, any authentication request from other PLC modems 100 for a time period from start of an authentication process by a PLC modem 100 to a predetermined point in time (hereinafter referred to as a “setup period”) during which no authentication requests from the other PLC modems must be confirmed in order to avoid an authentication error. In this example, the controller 10 monitors, in an authentication process, any authentication request from other PLC modems 100 for a time period from a predetermined point in time before start of an authentication process by a PLC modem 100 to the end of the setup period (hereinafter referred to as a “monitoring period”) to perform the authentication process. The relationship between the setup period and the monitoring period is shown in FIG. 1A.

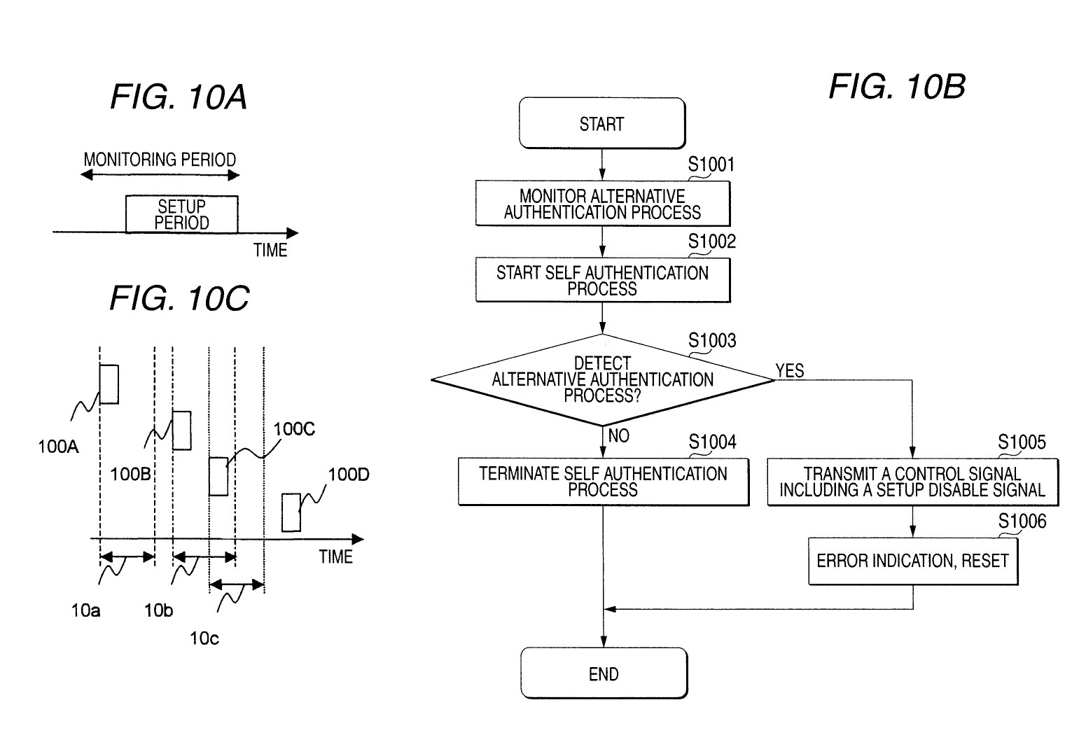

FIG. 10B shows an example of the operation flow of a PLC modem 100A in an authentication process using a monitoring period. FIG. 10B shows two authentication processes. One is between two PLC modems (a PLC modem 100C functioning as a master unit and a PLC modem 100D functioning as a slave unit) and the other is between other than the PLC modems (a PLC modem 100A and a PLC modem 100B). In this example, the authentication process between the PLC modem 100A and the PLC modem 100B is referred to as the “self authentication process” and the authentication process between the PLC modem 100C and the PLC modem 100D is referred to as the “alternative authentication process”.

The controller 10 performs monitoring of the alternative authentication process within the monitoring period (step S1001) and performs the self authentication process within the setup period (step S1002).

After starting the self authentication process, the controller 10 determines whether an alternative authentication process is under way (step S1003).

A memory 240 sequentially acquires and records various types of process information such as a communication process. In the monitoring period before the setup period starts, the controller 10 may determine whether an alternative authentication process is under way based on the process information.

Whether an alternative authentication process is under way is determined based on whether the controller 10 has detected more than one setup starting signal within the monitoring period. In case more than one setup starting signal has been detected, it may be determined that an alternative authentication process is under way at that point in time.

In case an alternative authentication process is not under way, the controller 10 and the communication part 20 perform the self authentication process until it is complete (step S1004) to terminate the authentication process.

In case an alternative authentication process is under way, the self authentication process is canceled and the indicator 105 gives an error indication using an LED and the controller 10 resets various settings to the initial state (step S1006) to complete the process. An error indication makes it possible to detect that an alternative authentication process is under way at that point in time.

The communication part 20 may transmit a control signal including a setup disable signal before an error indication is given (step S1005). In case a setup disable signal is considered, while a control signal including a setup disable signal is transmitted before an error indication is given in this example, this order may be reversed. Use of a setup disable signal makes it possible to notify other PLC modems 100 that an alternative authentication process is under way, thus ensuring a safer and more reliable authentication process in a network.

Performing an authentication process using a monitoring period provides the following advantages.

For example, FIG. 10C shows a situation where there are four PLC modems 100A through 100D. The authentication process between the PLC modem 100A and the PLC modem 100B and the authentication process between the PLC modem 100C and the PLC modem 100D may fail because the authentication process cannot be performed within the setup period 10a of the PLC modem 100A and the setup period 10c of the PLC modem 100C. The authentication process between the PLC modem 100B and the PLC modem 100C may complete successfully because the authentication process can be performed within the setup period 10b of the PLC modem 100B. This situation could happen for example in case the PLC modem 100A and the PLC modem 100B are distant from each other and the setup button 106 of the PLC modem 100B cannot be pressed just after the setup button 106 of the PLC modem 100A is pressed. Even in such a situation, it is possible to monitor a setup starting signal from another PLC modem 100 earlier than the start of the self authentication process, thus assuring a more correct authentication process.

Next, the operation of a PLC modem 100 in an authentication process using the monitoring period in an example other than that in FIG. 10 will be described.

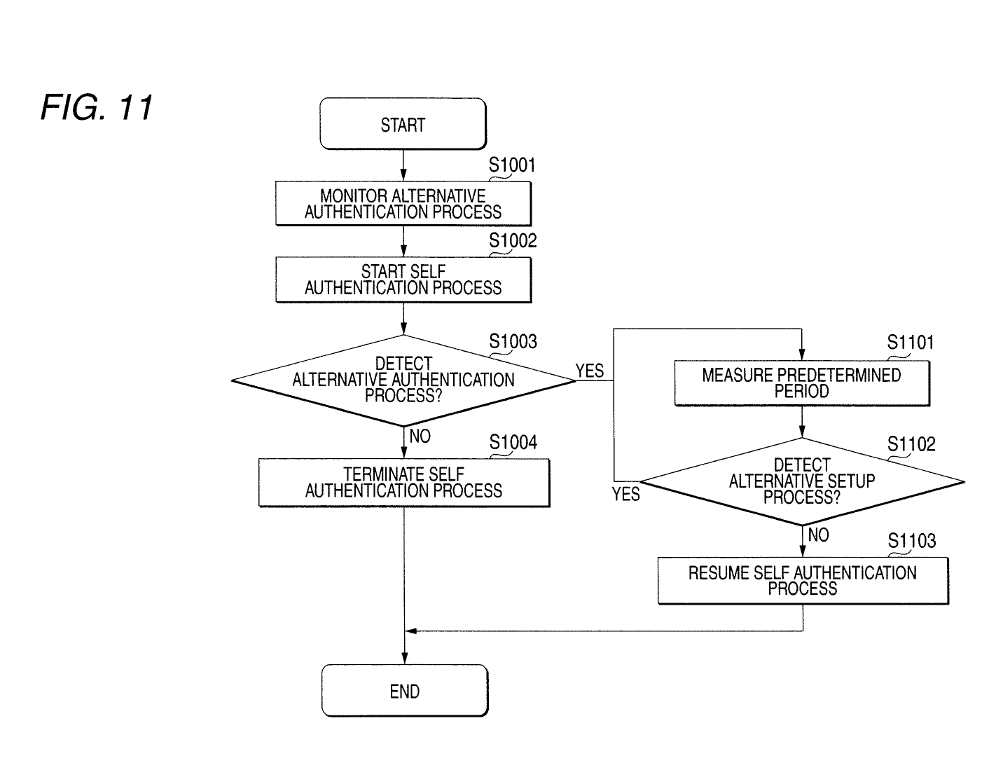

FIG. 11 shows an example of the operation of a PLC modem 100A in an authentication process using a monitoring period. A same numeral is given to the same process as that in FIG. 10B and the corresponding description is omitted.

The example in FIG. 11 is different from that in FIG. 10B in the following way. In case it is determined in step S1003 that an alternative authentication process is under way, the self authentication process is suspended and the controller 10 waits until a predetermined period elapses on a timer (not shown) (step S1101) and determines whether the alternative authentication process is still under way at the point in time the predetermined period has elapsed (step S1102). In case the alternative authentication process is still under way at the point in time the predetermined period has elapsed, execution returns to step S1101 where the controller 10 waits until the predetermined period elapses. In case the alternative authentication process is complete at the point in time the predetermined period has elapsed, the controller 10 and the communication part 20 resume the self authentication process (step S1103) to complete the process. The above predetermined period may be a random period or a fixed period in which an alternative authentication process is not detected very often.

In this way, in case an alternative authentication process is under way, it is possible to resume the self authentication process after the alternative authentication process is terminated. Once started, the self authentication process may operate until it is successfully terminated.

Next, the operation of a PLC modem 100 assumed in case a setup period can be flexibly specified instead of using a monitoring period will be described.

Examples of the method for specifying a setup period include the following: a period proportional or inversely proportional to a period in which the setup button 106 is pressed (continuous pressing time) may be specified as a setup period. Arrangement may be made so that, in case an authentication process is performed between a PLC modem 100A and a PLC modem 100B, the controller 10 may change the setup period when the setup button 106 of the PLC modem 100A and the setup button 106 of the PLC modem 100B are pressed successively for example within several seconds.

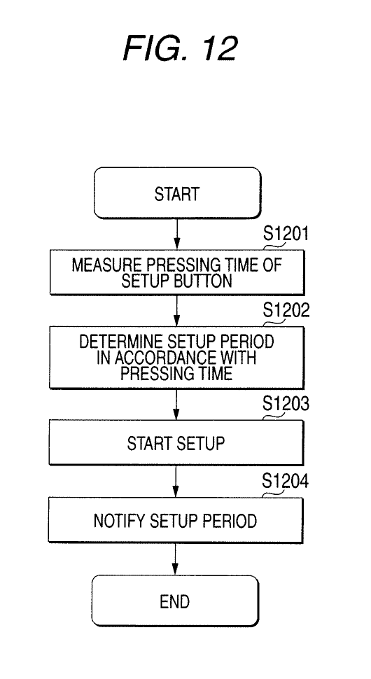

FIG. 12 shows an example of the operation of a PLC modem 100 to change the setup period. Referring to FIG. 12, a method for changing the setup period corresponding to the pressing time of the setup button will be described. First, the controller 10 measures the pressing time of the setup button (step S1201). In accordance with the measurement result of the pressing time, the controller 10 determines a setup period (step S1202). After the setup period is determined, the controller 10 starts the setup procedure (step S1203). When setup is made, the communication part 20 may notify other PLC modems 100 of the setup period used for setup in the control signal (step S1204).

In this way, it is possible to flexibly change the setup period thus ensuring a more correct authentication process.

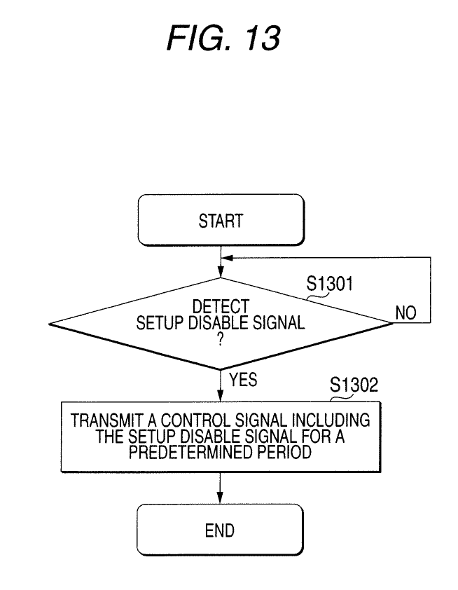

Next, the operation of a PLC modem 100 that has detected a setup disable signal from another PLC modem 100 will be described. FIG. 13 shows an example of the operation of a PLC modem 100 that has detected a setup disable signal from another PLC modem 100.

The controller 10 monitors a setup disable signal transmitted by another PLC modem 100 with each predetermined monitoring period (step S1301). Even in case a setup disable signal is not detected in step S1301, the controller 10 continues monitoring.

In case the controller 10 has detected a setup disable signal, the controller 10 transmits a control signal including a setup disable signal for a predetermined period (step S1302). This allows the PLC modem 100 that has detected a setup disable signal to transmit the same to other PLC modems in order to make it notify that an authentication process is currently disabled in the same network.

The setup disable signal may be included in a signal composed of a control signal such as a beacon, polling or a token, or in an ordinary data frame. The predetermined period may be a period determined by a random variable or a predetermined period such as 5 seconds or 10 seconds.

In this way, a PLC modem 100 that has detected a setup disable signal from another PLC modem 100 may transmit a signal including the setup disable signal thus allowing the other PLC modems 100 to perform a more correct authentication process.

With the foregoing authentication process method, it is possible to reliably perform an authentication process between desired PLC modems even in case a plurality of PLC modems 100 on a network are connected a power line 700.

Next, a method for confirming the registration status indicating whether an authentication process is complete will be described.

This method indicates the number of PLC modems 100 for which an authentication process is complete among the other PLC modems 100 and the authentication confirmation results in order to confirm the registration status.

A device registration list 241 registering information on each PLC modem 100 is stored in a memory 240 for confirmation of a registration status. The device registration list 241 may include information such as the device number and MAC address of each PLC modem 100, a status (registered/unregistered) indicating whether an authentication process has been made with another PLC modem 100, a type (master/slave unit) of each PLC modem 100 and whether each PLC modem 100 is currently connected and is operating. The device registration list 241 is updated by the controller 10 of the PLC modem 100A in case an authentication process is performed between a master unit and a slave unit and transmitted to the PLC modem 100B. This allows the PLC modem 100A and the PLC modem 100B to maintain the latest device registration list 241 in the memory 240 at all times. By referencing the device registration list 241, a PLC modem 100 can transmit a registration confirmation signal to instruct confirmation of a registration status to other PLC modems 100 registered on the device registration list 241 and indicate the number of other PLC modems 100 for which an authentication process is complete with the PLC modem 100.

It is possible to reflect the latest registration information obtained by each PLC modem during ordinary communications as well as the information on the registered devices into the device registration list 241. To be more precise, for example, PLC modems may exchange signals to each other to detect in real time whether a currently registered modem is operating in the normal mode or unregistered mode, thereby obtaining the latest registration information. The registration information is updated with each predetermined period and thus the device registration list 241 includes the latest registration status at all times.

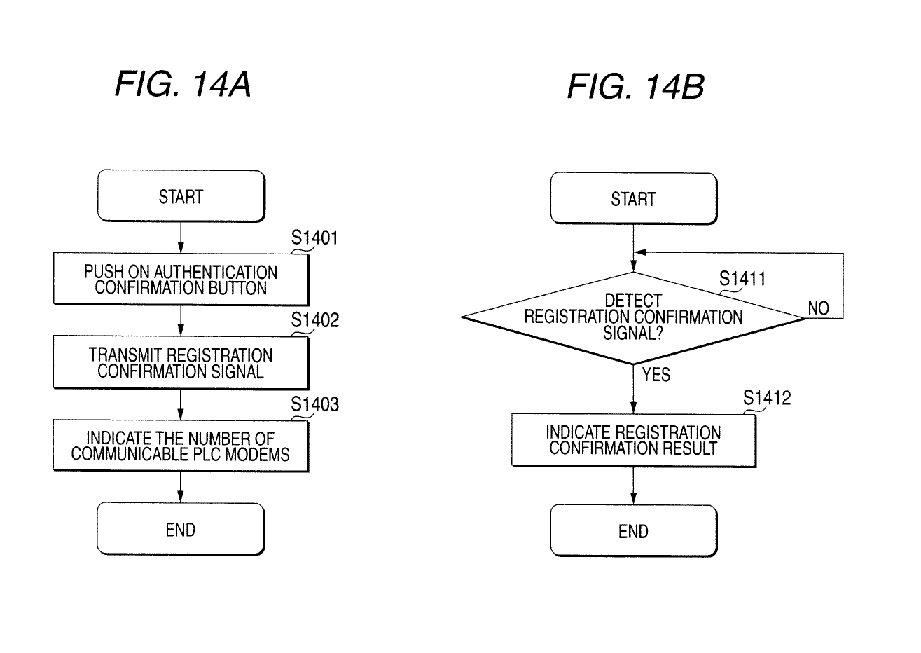

Operation of a PLC modem 100 in confirmation of the registration status will be described referring to FIGS. 14A and 14B.

First, the operation of the PLC modem 100 transmitting a registration confirmation signal to instruct confirmation of the registration status will be described referring to FIG. 14A.

In case registration confirmation between a PLC modem 100 and another PLC modem 100 constituting a power line network is made, when the controller 10 detects a push on the authentication confirmation button 106 of the PLC modem 100 (step S1401), the communication part 20 transmits a registration confirmation signal to other PLC modems 100 registered in the device registration list 241 based on the device registration list 241 (step S1402). When a registration confirmation signal is transmitted, the indicator 105 of the PLC modem 100 indicates the number of communicable PLC modems 100 based on the device registration list 241 (step S1403).

Next, the operation of the PLC modem 100 receiving a registration confirmation signal will be described referring to FIG. 14B.

When the communication part 20 detects a registration confirmation signal from another PLC modem 100 (step S1411), the indicator 105 indicates the registration confirmation result (step S1412). To indicate the registration confirmation result, the indicator 105 may cause an LED to blink or illuminate in a different color. Any sound or voice may be used, for example, to notify the registration confirmation result instead of the indication on the indicator 105.

As shown in FIGS. 14A and 14B, a PLC modem 100 including only the transmission function, the transmission and modem count indication functions, the transmission and receiving functions, a combination of the modem count indication, transmission and receiving functions, or other combinations may be used.

In this way, by indicating the number of modems and registration confirmation result, it is possible to know, correctly and at the same time, the number and identity of PLC modems 100 for which an authentication process is complete.

In case the number of PLC modems 100 for which an authentication process is complete differs from the number of PLC modems 100 for which the registration confirmation result is indicated, it is possible to detect intercept for example by an external PLC modem. In case the PLC modems 100 for which the registration confirmation result is indicated differs from those expected, it is possible to detect a registration error in an authentication process. In case the number of PLC modems 100 for which an authentication process is complete differs from the number of PLC modems 100 that are expected to have undergone an authentication process, it is possible to detect a PLC modem 100 left unregistered.

With such registration status confirmation, it is possible to confirm that an authentication process has been reliably performed between desired PLC modems in case a plurality of PLC modems 100 exist on a network.

As a simple approach, the communication part 20 of a PLC modem 100 may just indicate the number of communicable PLC modems 100 based on the device registration list 241 without transmitting a registration confirmation signal (step S1402) to other PLC modems 100 registered in the device registration list 241 based on the device registration list 241.

A single button may serve as a setup button and an authentication confirmation button by changing the way of pressing the button. For example, the button may function as a setup button when held down for at least one second and as an authentication confirmation button when pressed for a duration less than one second.

This application is based upon and claims the benefit of priority of Japanese Patent Application No. 2007-32113 filed on Feb. 13, 2007, the contents of which is incorporated herein by references in its entirety.

What is claimed is:

1. A power line communication apparatus capable of performing power line communications with an other power line communication apparatus, the power line communication apparatus, comprising:
an authentication processing part which performs an authentication process using at least either an authentication request signal or an authentication response signal with the other power line communication apparatus via a power line; and
a signal transmitting part which transmits a predetermined signal to the other power line communication apparatus so that the other power line communication apparatus indicates that the power line communication apparatus and the other power line communication apparatus are made communicatable to each other by the authentication process.

2. The power line communication apparatus according to claim 1, further comprising an operation part that is operable,
wherein the signal transmitting part transmits the predetermined signal to the other power line communication apparatus in accordance with operation of the operation part.

3. The power line communication apparatus according to claim 2, further comprising a storage part for storing device registration information indicating a registration status of at least one of a plurality of the other power line communication apparatuses,
wherein the signal transmitting part transmits the predetermined signal to the other power line communication apparatuses connected to the power line and causes an indicator to indicate the number of the other power line communication apparatuses that are communicatable while referencing the device registration information stored in the device registration information storage part.

4. The power line communication apparatus according to claim 2, further comprising a signal receiving part which receives a predetermined signal,
wherein the signal receiving part causes the indicator of the power line communication apparatus to indicate that the power line communication apparatus and the other power line communication apparatus are made communicatable to each other in case the signal receiving part receives the predetermined signal from other power line communication apparatus connected to the power line.

5. The power line communication apparatus according to claim 2, wherein the operation part starts the authentication process to enable communications with the other power line communication apparatus; and
wherein the authentication processing part transmits a setup starting signal notifying that the authentication process is to take place after the operation of the operation part.

6. The power line communication apparatus according to claim 5, wherein the authentication processing part transmits the setup starting signal in case the authentication processing part receives one or fewer setup starting signal from the other power line communication apparatuses within the predetermined period after the operation of the operation part.

7. The power line communication apparatus according to claim 6, wherein the authentication processing part transmits the setup starting signal with a transmitting power thereof reduced below a transmitting power of the authentication response signal.

8. The power line communication apparatus according to claim 7, wherein the authentication processing part retransmits the setup starting signal with increased transmitting power in case the authentication processing part fails to receive a response from the other power line communication apparatus within a predetermined period after detecting the operation of the operation part.

9. The power line communication apparatus according to claim 5, wherein the authentication processing part, transmits a setup disable signal notifying that the authentication process is disabled to the other power line communication apparatuses in case the authentication processing part receives responses from a plurality of the other power line communication apparatuses within a predetermined period after detecting the operation of the operation part.

10. The power line communication apparatus according to claim 6, wherein the authentication processing part changes a length of the predetermined period to monitor reception of the setup starting signal from the other power line communication apparatuses based on a operation time of the operation part.

11. The power line communication apparatus according to claim 1, wherein a diversity signal is employed as a signal used for the authentication process.

12. The power line communication apparatus according to claim 11, wherein a frequency diversity signal utilizing a frequency region is used as the diversity signal.

13. The power line communication apparatus according to claim 11, wherein a time diversity signal utilizing a time region is used as the diversity signal.

14. The power line communication apparatus according to claim 11, wherein a frequency-time diversity signal utilizing a frequency region and a time region is used as the diversity signal.

15. A registration status confirmation method for confirming a registration status between power line communication apparatuses performing power line communications via a power line, the method comprising:
transmitting a registration status confirmation signal instructing confirmation of the registration status from a first power line communication apparatus connected to the power line to a second power line communication apparatus connected to the power line; and
indicating that the second power line communication apparatus is communicatable to the first power line communication apparatus in the second power line communication apparatus that receives the registration status confirmation signal.

16. The registration status confirmation method according to claim 15, comprising:
transmitting, by the first power line communication apparatus, the registration status confirmation signal and indicating information including a number of the second power line communication apparatuses that are communicatable to the first power line communication apparatus while referencing device registration information indicating the registration status between the power line communication apparatuses.

17. The registration status confirmation method according to claim 15, comprising:
transmitting, by the first power line communication apparatus, a setup starting signal notifying that an authentication process is to take place, after starting the authentication process to enable communications with the second power line communication apparatus.

18. The registration status confirmation method according to claim 15, wherein a diversity signal is employed as a signal used for the authentication process.

19. The registration status confirmation method according to claim 15, comprising:
indicating, by the first power line communication apparatus connected to the power line, information including a number of the second power line communication apparatuses that are communicatable based on device registration information indicating the registration status of the second power line communication apparatuses.

20. A power line communication system in which power line communications are enabled by a first power line communication apparatus and a second power line communication apparatus,
wherein the second power line communication apparatus transmits an authentication request signal via a power line;
wherein the first power line communication apparatus transmits an authentication response signal in response to the authentication request signal; and
wherein the first power line communication apparatus transmits a predetermined signal to the second power line communication apparatus to allow the second power line communication apparatus to indicate that the first power line communication apparatus and the second power line communication apparatus are made communicatable to each other by way of an authentication process using the authentication request signal and the authentication response signal.
